(19) United States
(12) Patent Application Publication
(10) Pub. No.: US 2022/0196079 A1
(43) Pub. Date: Jun. 23, 2022

(54) BELT PULLLEY DECOUPLER WITH SPRINGS CONNECTED IN PARALLEL

(71) Applicant: Schaeffler Technologies AG & Co. KG, Herzogenaurach (DE)

(72) Inventors: Melanie Sillmann, Baden-Baden (DE); Benjamin Severin, Baiersbronn (DE); Daniel Hirsch, Karlsruhe (DE); Andreas Stuffer, Weingarten (DE)

(73) Assignee: Schaeffler Technologies AG & Co. KG, Herzogenaurach (DE)

(21) Appl. No.: 17/441,723

(22) PCT Filed: Mar. 23, 2020
(86) PCT No.: PCT/DE2020/100227

§ 371 Date: Sep. 22, 2021

(30) Foreign Application Priority Data
Mar. 27, 2019 (DE) 10 2019 107930.6

(51) Int. Cl. F16D 3/14; F16F 15/121; F16F 15/123; F16H 55/36

(52) U.S. Cl. CPC F16D 3/14; F16F 15/1215; F16D 2300/22; F16H 55/36; F16H 2055/366; F16F 15/12373

(57) ABSTRACT

A belt pulley decoupler for a motor vehicle drive train, having a hub, a traction pulley having a traction-means receiving contour and being accommodated to rotate about an axis of rotation relative to the hub. The decoupler may include a plurality of bow springs supporting the traction pulley relative to the hub in a direction of rotation, at least one first bow spring being arranged offset in an axial direction and/or a radial direction of the axis of rotation to a second bow spring acting parallel to the first bow spring, and a vibration damping device conjointly connected by means of a carrier to the hub and accommodated on a sleeve-like receiving region of the carrier. The receiving region of the carrier projecting in the axial direction, at least partially, beyond the torque transfer region of the traction pulley.

### CROSS-REFERENCE TO RELATED APPLICATIONS

This application is the U.S. National Phase of PCT Appln. No. PCT/DE2020/100227 filed Mar. 23, 2020, which claims priority to DE 102019107930.6 filed Mar. 27, 2019, the entire disclosures of which are incorporated by reference herein.

### TECHNICAL FIELD

The disclosure relates to a belt pulley decoupler for a motor vehicle drive train, i.e., a drive train of a motor vehicle, such as a car, truck, bus or other utility vehicle, having a hub, a traction pulley having a traction-means receiving contour and being accommodated to rotate about an axis of rotation relative to the hub, a plurality of bow springs supporting the traction pulleys relative to the hub in a direction of rotation, at least one first bow spring being arranged offset in an axial direction and/or a radial direction of the axis of rotation to a second bow spring acting parallel to the first bow spring, and a vibration damping device conjointly connected by means of a carrier to the hub, and accommodated on a sleeve-like receiving region of the carrier.

### BACKGROUND

Generic belt pulley decouplers are already known from the prior art. Accordingly, DE 10 2010 052 587 A1 discloses, for example, a drive pulley having an output part and a first input part connected to a drive shaft, the output part and the first input part being connected to one another via a first damping device. A second input part connected to the drive shaft is connected to the output part via a second damping device.

Further prior art is known from DE 10 2009 005 740 A1, WO 2008/071306 A1 and WO 2007/118441 A2.

However, in the embodiments known from the prior art there is often the disadvantage that the implemented belt pulley decouplers take up a relatively large amount of installation space, especially in the axial direction, when a plurality of parallel-connected bow springs are used.

### SUMMARY

Therefore, the object of the present disclosure is to eliminate the disadvantages known from the prior art and, in particular, to provide a belt pulley decoupler which has the highest possible bow spring capacity and is implemented in a compact manner.

This is achieved according to the disclosure in that the receiving region of the carrier at least partially projects in the axial direction beyond a torque transfer region of the traction pulley that directly forms the traction-means receiving contour and runs in the axial direction, and also project in the axial direction beyond at least one of the bow springs.

This means that the existing components are particularly cleverly nested. This enables a space-saving design in order to implement the entire belt pulley decoupler axially in a particularly compact manner.

Further advantageous embodiments are explained in more detail below.

Accordingly, it is also advantageous if the receiving region projects with its free end into an intermediate space, which intermediate space is formed radially between the torque transfer region and at least one (first) support region supported on the first bow spring or is formed by a plurality of support regions of the traction pulley supported on the first and second bow springs. As a result, the installation space available in the radial direction is used even more intensively.

If at least one support region is formed by a base body of the traction pulley that directly forms the traction-means receiving contour and/or by an element connected to the base body (cover element and/or additional part), the bow springs can be arranged variably relative to one another.

For the damping effect of the belt pulley decoupler, it is also advantageous if a friction device is actively inserted between the carrier and the traction pulley. The friction device typically has at least one friction ring, which is pressed against one of two components (traction pulley or carrier) via a spring and generates friction that inhibits relative rotation between the traction pulley and the carrier during operation.

If the vibration damping device is arranged partially or completely radially inside the torque transfer region, the radial nesting is further improved.

Furthermore, it is advantageous for an even more compact design if the first bow spring is arranged radially inside the receiving region.

If the first bow spring is at least partially accommodated in an axial hollow space formed by the carrier (and limited radially outward by the receiving region), the installation space is made even more compact.

It has also been found to be expedient if the second bow spring is arranged in the radial direction at the same height as the first bow spring or, more preferably, further outwards in the radial direction than the first bow spring. As a result, the belt pulley decoupler can be arranged in an axially compact manner in different ways. The first bow springs therefore either have the same effective radius or a different effective radius as the second bow springs.

In this context, it is also advantageous if the second bow spring is arranged in the axial direction next to the receiving region and in the radial direction at the height of the receiving region or is arranged in the radial direction inside the receiving region.

If the receiving region extends so far in the axial direction that it overlays/overlaps/projects beyond both the first bow spring and at least part of the second bow spring in the axial direction, the receiving region and the vibration damping device are arranged particularly far into the traction pulley.

For receiving and assembling the bow springs it is also advantageous if the first bow spring is supported with a first circumferential end on a first flange element attached to the hub and with a second circumferential end on the traction pulley. The second bow spring is expediently supported with a first circumferential end on a second flange element fastened to the hub and formed separately from the first flange element, and with a second circumferential end on the side of the traction pulley.

In other words, according to the disclosure, a special parallel connection of springs is implemented in a belt pulley decoupler. Axial installation space that was previously unused is, on the one hand, used by means of the parallel connection of the springs. The parallel connection offers the possibility to set the characteristics of the individual springs in a targeted manner. The acoustics can thus be improved, in particular when a clearance angle is omitted. Furthermore, a special nesting with an elastomer, viscous, or centrifugal pendulum damper (vibration damping device) is provided.

### BRIEF DESCRIPTION OF THE DRAWINGS

The disclosure will now be explained in more detail with reference to figures, in which context various exemplary embodiments are also shown.

In the figures:

FIG. 1 shows a longitudinal sectional view of a belt pulley decoupler according to the disclosure according to a first exemplary embodiment, and

FIG. 2 shows a longitudinal sectional view of a belt pulley decoupler according to a second exemplary embodiment, in which, among other things, the arrangement of a plurality of first and second bow springs connected parallel to one another differs from the first exemplary embodiment.

The figures are only schematic in nature and serve exclusively for understanding the disclosure. The same elements are provided with the same reference symbols. The different features of the various exemplary embodiments can in principle also be freely combined with one another.

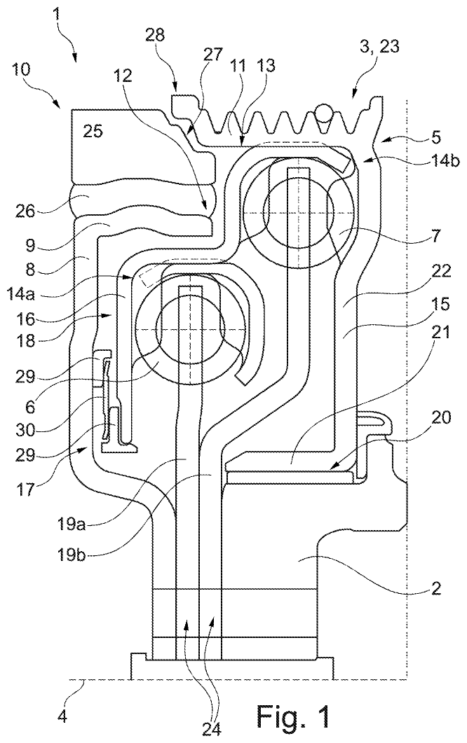

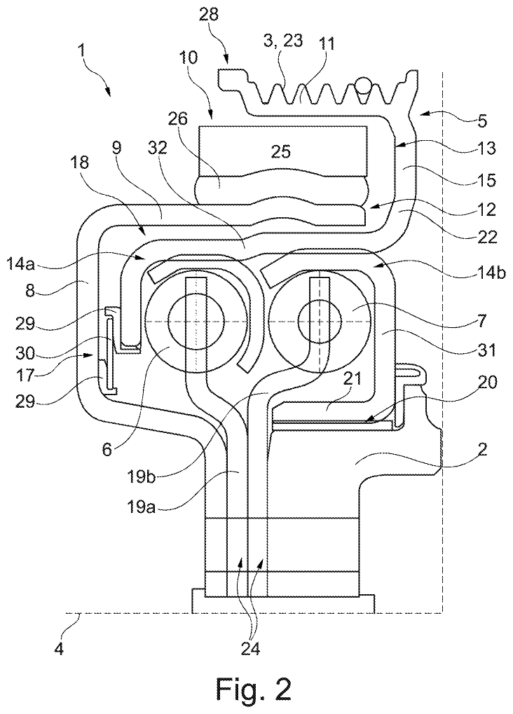

Since the two exemplary embodiments of FIGS. 1 and 2 are identical in terms of the function thereof and the basic structure thereof, for the sake of brevity, only the differences between these two exemplary embodiments will be discussed below.

### DETAILED DESCRIPTION

FIG. 1 clearly shows the structure of a belt pulley decoupler 1 according to the disclosure according to a first exemplary embodiment. The belt pulley decoupler 1 typically has a hub 2 which, during operation, is conjointly connected to a shaft (not shown here for the sake of clarity), for example a crankshaft of an internal combustion engine. The hub 2 is arranged to be rotatable about a central axis of rotation 4. A traction pulley 5 is mounted so as to be relatively rotatable relative to the hub 2. The traction pulley 5 is typically coupled to an auxiliary unit during operation via a continuous traction means, here a belt.

The directions used—radial, axial, and circumferential—relate to the central axis of rotation 4. Consequently, axially/an axial direction is a direction along the axis of rotation 4, radially/a radial direction is a direction perpendicular to the axis of rotation 4, and a circumferential direction is a direction along a circular line that runs concentrically around the axis of rotation 4.

A slide bearing 20 is used to support the traction pulley 5 relative to the hub 2. The traction pulley 5 has a base body 15, this base body 15 also having a sleeve-like bearing region 21, which is supported on the radial inside thereof via the sliding bearing 20 on a radial outer side of the hub 2.

From an axial end of the bearing region 21, a pulley region 22 of the traction pulley 5/base body 15 extends outward in the radial direction and, towards an outside, again merges into an axially running, substantially sleeve-like torque transfer region 11. The torque transfer region 11 of the traction pulley 5/base body 15 has on the radial outer side thereof a groove contour 23, which runs in the circumferential direction as a traction-means receiving contour 3 to accommodate a belt of a continuous traction drive during operation. Since the torque transfer region 11 and the bearing region 21 extend away toward the same axial side of the pulley region 22, the main body 15 as a whole is implemented in a substantially trough-shaped/pot-shaped manner.

The traction pulley 5 is furthermore resiliently supported relative to the hub 2 by means of a plurality of bow springs 6, 7. The belt pulley decoupler 1 has a plurality of first bow springs 6 arranged distributed in the circumferential direction and a plurality of second bow springs 7 arranged distributed in the circumferential direction, only a first bow spring 6 and a second bow spring 7 being illustrated for the sake of clarity in FIG. 1. The first bow springs 6 are described below by way of example with reference to the illustrated first bow spring 6; the second bow springs 7 are described below by way of example with reference to the illustrated second bow spring 7. The first bow springs 6 and the second bow springs 7 are arranged/connected parallel to one another, i.e., arranged in a parallel connection relative to one another. Accordingly, the first bow springs 6 and the second bow springs 7 are loaded simultaneously/parallel to one another when the hub 2 is rotated relative to the traction pulley 5 and are compressed from a certain torque to be transferred.

The first bow spring 6 in FIG. 1 is the bow spring that is offset further inward in the radial direction. The first bow spring 6 is therefore arranged radially inside the second bow spring 7 and offset in the axial direction from the second bow spring 7. The first bow spring 6 is located at least partially in the axial direction at the same height as the torque transfer region 11. The first bow spring 6 is thus partially overlaid by the torque transfer region 11 radially from the outside. The first bow spring 6 is supported with a first circumferential end on the hub 2, namely on a first flange element 19a fastened to the hub 2. At a second circumferential end opposite the first end, the first bow spring 6 is supported on the traction pulley side. For this purpose, the traction pulley 5 forms a first support region 14a. In the first exemplary embodiment, the first support region 14a is provided on a cover element 16 that is formed separately from the base body 15 but is connected to the base body 15.

The second bow spring 7 is displaced further into the base body 15 in the axial direction compared to the first bow spring 6. The second bow spring 7 is completely overlapped over the entire axial extent thereof by the torque transfer region 11 radially from the outside. The second bow spring 7 is supported with the first circumferential end thereof on a second flange element 19b that is also conjointly connected to the hub 2. The second flange element 19b is fastened to the hub 2 like the first flange element 19a. A second circumferential end of the second bow spring 7 opposite the first circumferential end is supported on the traction pulley side. For this purpose, the traction pulley 5 forms a second support region 14b. The second support region 14b is implemented both by the cover element 16 and by the base body 15.

At the radially inner fastening regions 24 thereof, the two flange elements 19a, 19b lie flat against one another. The second flange element 19b also lies directly flat on the hub 2. Screw elements are typically provided to connect the two flange elements 19a, 19b to the hub 2.

A vibration damping device 10 is also provided. The vibration damping device 10 is implemented in this embodiment as an elastomer damper. According to further embodiments according to the disclosure, however, the vibration damping device 10 can alternatively be implemented as a centrifugal pendulum damper or as a viscous damper. The vibration damping device 10 is accommodated on a carrier 8 connected to the hub 2. The carrier 8 is entirely pot-shaped/trough-shaped. The carrier 8 forms a hollow space 18 that is open axially in the direction of the traction pulley 5. The hollow space 18 is delimited radially outwardly by a sleeve-like receiving region 9 of the carrier 8 that runs in the axial direction. The vibration damping device 10 is arranged directly on this receiving region 9 on a radial outer side of the receiving region 9. In this embodiment, as an elastomer damper, the vibration damping device 10 has a damping mass 25 and an elastomer layer 26 that has a resilient effect. The damping mass 25 is fastened to the receiving region 9 via the elastomer layer 26.

According to the disclosure, the receiving region 9, viewed in the axial direction, is arranged at least partially overlapping the torque transfer region 11. The torque transfer region 11 is arranged radially outside of the receiving region 9 and in the first exemplary embodiment projects partially axially beyond both the receiving region 9 and the vibration damping device 10 in the radial direction from the outside. The damping mass 25 is equipped with a recess 27 that is shaped to be complementary to a free end region 28 of the torque transfer region 11. The carrier 8 as a whole is shaped and arranged relative to the traction pulley 5 such that it also partially overlays/projects beyond the first bow spring 6 in the axial direction. The receiving region 9 thus extends axially beyond the first bow spring 6 radially from the outside by a certain distance. In other words, the receiving region 9 extends with its free end 12 into a radial intermediate space 13 formed by the traction pulley 5 and open towards the vibration damping device 10.

In this embodiment, the second bow spring 7 is also arranged in the radial direction at the height of the receiving region 9 and the vibration damping device 10. The second bow spring 7 is, however, arranged to be axially offset from the receiving region 9 and the vibration damping device 10.

Furthermore, a friction device 17 is actively inserted between the carrier 8 and the traction pulley 5. The friction device 17 typically has two friction rings 29, one of which rests on the carrier 8 and the other of which rests on the traction pulley side, here on the cover element 16, as well as a spring 30 in the form of a disk spring. As a result, the friction device 17 has a braking effect on a relative movement between the traction pulley 5 and the carrier 8 during operation.

As can also be seen in relation to FIG. 2 with regard to the second exemplary embodiment, the bow springs 6 and 7 can alternatively also be placed in a different manner relative to one another. In this second exemplary embodiment, the first bow springs 6 are arranged in the radial direction at the same height as the second bow springs 7. This means that the respective bow springs 6, 7 are arranged with the central axes thereof running in the circumferential direction at the same height in the radial direction. The first and second bow springs 6 and 7 are arranged to be adjacent to one another in the axial direction.

Furthermore, the traction pulley 5 in FIG. 2 is configured in a different way than in FIG. 1. The traction pulley 5 is now implemented in such a way that the base body 15, which has the traction-means receiving contour 3 on the torque transfer region 11 thereof, is no longer supported directly on the hub 2. An additional part 31 is now provided for mounting the traction pulley 5 relative to the hub 2, which additional part 31 comprises the bearing region 21. From the bearing region 21, the additional part 31 extends outward in the radial direction and is firmly connected on a radially outer side to the base body 15. At the same time, the additional part 31 forms the second support region 14b.

The base body 15, which forms the torque transfer region 11, has on the radial inner side thereof a sleeve-like intermediate region 32, which projects axially beyond the bow springs 6, 7 in the radial direction outside thereof. This intermediate region 32 also accommodates the first support region 14a.

Furthermore, with regard to the vibration damping device 10, it can be seen that due to the arrangement of the first and second bow springs 6 and 7 in the radial direction at the same height, the vibration damping device 10 together with the receiving region 9 is shifted inward further in the axial direction in the intermediate space 13 of the traction pulley 5/base body 15 than in the first exemplary embodiment. The receiving region 9 and the vibration damping device 10 overlay both the first bow springs 6 and the second bow springs 7 in the axial direction and are arranged radially outside thereof.

In other words, according to the disclosure, by connecting springs (first and second bow springs 6, 7) in parallel, the size of the previously largest first spring of a spring set can be reduced, since the coil radius of the second spring (currently the inner spring) is not limited by the outer spring. This increases the spring capacity in the existing installation space. In addition, this parallel connection offers the possibility of setting the characteristics of the individual springs 6, 7 in a targeted manner. In this way, current acoustic problems can be solved, since a previously existing clearance angle can be omitted. In addition to the bow springs 6, 7, the belt pulley decoupler 1 according to the disclosure has metal sheets that guide them and flanges that are responsible for the torque flow in the usual way.

### LIST OF REFERENCE NUMBER

1 Belt pulley decoupler

2 Hub

3 Traction-means receiving contour

4 Axis of rotation

5 Traction pulley

6 First bow spring

7 Second bow spring

8 Carrier

9 Receiving region

10 Vibration damping device

11 Torque transfer region

12 Free end

13 Intermediate space

14a First support region

14b Second support region

15 Base body

16 Cover element

17 Friction device

18 Hollow space

19a First flange element

19b Second flange element

20 Sliding bearing

21 Bearing region

22 Pulley region

23 Groove contour

24 Fastening region

25 Damping mass

26 Elastomer layer

27 Recess

28 End region

29 Friction ring

30 Spring

31a First part

31b Second part

32 Intermediate region

1. A belt pulley decoupler for a motor vehicle drive train, comprising:
a hub,
a traction pulley having a traction-means receiving contour and being configured to rotate about an axis of rotation relative to the hub,
a plurality of bow springs supporting the traction pulley relative to the hub in a direction of rotation, at least one first bow spring being arranged offset in an axial direction or a radial direction of the axis of rotation to a second bow spring acting parallel to the first bow spring, and
a vibration damping device conjointly connected by a carrier to the hub and accommodated on a sleeve-like receiving region of the carrier, wherein the receiving region of the carrier projects in the axial direction, at least partially, beyond a torque transfer region of the traction pulley, the torque transfer region forming the traction-means receiving contour and extending in the axial direction, and also beyond at least one of the bow springs.

2. The belt pulley decoupler according to claim 1, wherein the receiving region projects with its free end into an intermediate space formed radially between the torque transfer region and at least one support region supported on the first bow spring of the traction pulley.

3. The belt pulley decoupler according to claim 2, wherein the at least one support region is formed by a base body of the traction pulley which directly forms the traction-means receiving contour.

4. The belt pulley decoupler according to claim 2, wherein a friction device is actively inserted between the carrier and the traction pulley.

5. The belt pulley decoupler according to claim 1, wherein the vibration damping device is partially or completely arranged radially inside the torque transfer region.

6. The belt pulley decoupler according to claim 1, wherein the first bow spring is arranged radially inside the receiving region.

7. The belt pulley decoupler according to claim 6, wherein the first bow spring is at least partially accommodated in an axial hollow space formed by the carrier.

8. The belt pulley decoupler according to claim 1, wherein the second bow spring is arranged in the radial direction at the same height as the first bow spring or is arranged further outwards in the radial direction than the first bow spring.

9. The belt pulley decoupler according to claim 1, wherein the second bow spring is arranged in the axial direction next to the receiving region and in the radial direction at a height of the receiving region or is arranged in the radial direction inside the receiving region.

10. The belt pulley decoupler according to claim 1, wherein the receiving region extends so far in the axial direction that it overlaps both the first bow spring and at least part of the second bow spring in the axial direction.

11. The belt pulley decoupler according to claim 2, wherein the at least one support region is formed by an element connected to a base body of the traction pulley.

12. The belt pulley decoupler according to claim 1, wherein the receiving region projects with its free end into an intermediate space formed radially between support regions of the first and second bow springs of the traction pulley.
